(19) United States
(12) Patent Application Publication
(10) Pub. No.: US 2019/0227465 A1
(43) Pub. Date: Jul. 25, 2019

(54) IMAGE FORMING APPARATUS

(71) Applicant: TOSHIBA TEC KABUSHIKI KAISHA, Tokyo (JP)

(72) Inventor: Akitoshi SUZUKI, Mishima Shizuoka (JP)

(21) Appl. No.: 16/130,441

(22) Filed: Sep. 13, 2018

(30) Foreign Application Priority Data
Jan. 25, 2018 (JP) 2018-010449

(51) Int. Cl. G03G 15/20; G03G 15/16; G03G 15/08

(52) U.S. Cl. CPC G03G 15/2017; G03G 15/0808; G03G 15/0887; G03G 15/16

(57) ABSTRACT

An image forming apparatus comprises a first image forming section configured to form an image using a first toner, a second image forming section configured to form an image using a second toner, a controller configured to transfer a first toner image formed with the first toner by the first image forming section and a second toner image formed with the second toner by the second image forming section onto a medium, and a fixing device configured to perform a fixing process on the medium onto which the first toner image and the second toner image are transferred. The first toner image and the second toner image have a same pattern and are transferred onto the medium so as to be shifted with respect to each other.

### CROSS-REFERENCE TO RELATED APPLICATION

This application is based upon and claims the benefit of priority from Japanese Patent Application No. 2018-010449, filed Jan. 25, 2018, the entire contents of which are incorporated herein by reference.

### FIELD

Embodiments described herein relate generally to an image forming apparatus.

### BACKGROUND

An image forming apparatus having a function of printing an image of a test pattern on a medium such as a sheet so as to confirm a position where the image is printed is known. For example, the image forming apparatus which forms an image with decolorable toner and non-decolorable toner prints an image of a test pattern such that the image formed with the decolorable toner and the image formed with the non-decolorable toner overlap with each other. Based on a printing result of such a test pattern, an operator confirms a displacement between the image formed with the decolorable toner and the image formed with the non-decolorable toner.

However, in a case where a fixing ability is poor, there is a possibility that a toner which is not fixed well pollutes a roller used in the fixing. Although it is possible to improve the fixing property by increasing a fixing temperature, there is a problem that the image formed with the decolorable toner may be decolored when heated to a temperature that is too high.

### DESCRIPTION OF THE DRAWINGS

FIG. 1 is a diagram illustrating an example of a configuration of an image forming apparatus according to first and second embodiments;

FIG. 2 is a diagram illustrating an example of a configuration of a fixing device in the image forming apparatus according to the first and second embodiments;

FIG. 3 is a block diagram illustrating a control system of the image forming apparatus according to the first and second embodiments;

FIG. 4 is a diagram illustrating an example of printing a test pattern printed on a sheet by the image forming apparatus according to the first embodiment;

FIG. 5 is a diagram illustrating an example of printing a test pattern printed on the sheet by the image forming apparatus according to the second embodiment; and

FIG. 6 is a flowchart for depicting an example of a sheet conveyance control operation in the image forming apparatus according to the second embodiment.

### DETAILED DESCRIPTION

In accordance with an embodiment, an image forming apparatus comprises a first image forming section configured to form an image using a first toner, a second image forming section configured to form an image using a second toner, a controller configured to transfer a first toner image formed with the first toner by the first image forming section and a second toner image formed with the second toner by the second image forming section onto a medium, and a fixing device configured to perform a fixing process on the medium onto which the first toner image and the second toner image are transferred. The first toner image and the second toner image have a same pattern and are transferred onto the medium so as to be shifted with respect to each other.

Hereinafter, several embodiments will be described with reference to the accompanying drawings.

### First Embodiment

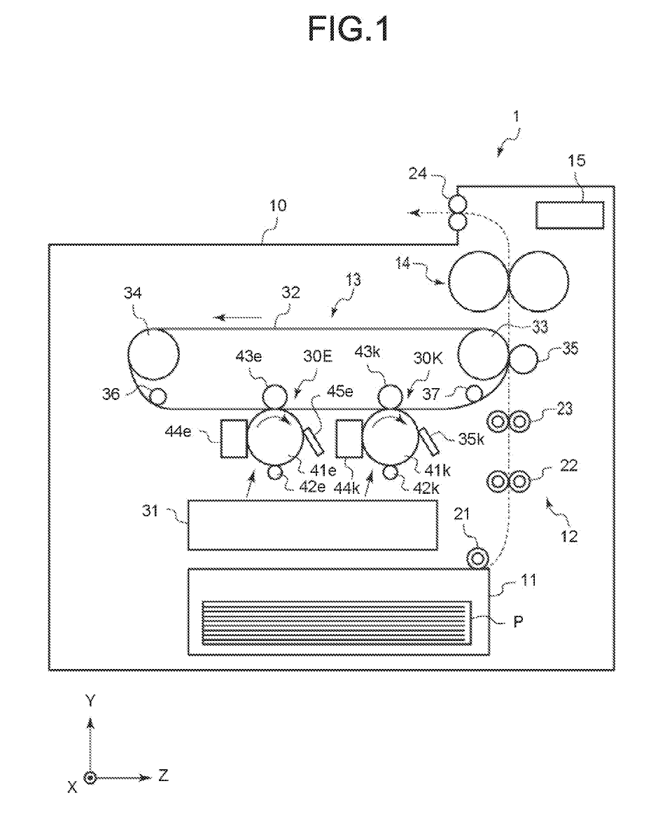

FIG. 1 is a diagram illustrating an example of a configuration of an image forming apparatus 1 according to the first embodiment.

The image forming apparatus 1 is a printer having a function of forming an image with decolorable toner and a function of forming an image with non-decolorable toner. The decolorable toner becomes transparent (i.e., decolored) by being heated to decoloring temperature. For example, the decolorable toner is a blue toner that can be decolored by heat. The non-decolorable toner is a toner whose color does not change due to the heat. For example, the non-decolorable toner may be a toner for forming a monochrome image such as black image, or toners of a plurality of colors for forming color images such as images of yellow, magenta, cyan, black or the like.

The image forming apparatus 1 includes a housing 10, a sheet feed cassette 11, a conveyance system 12, an image forming unit 13, a fixing device 14 and a controller 15. The image forming apparatus 1 may be connected with a scanner for reading an image of a document or a finisher for processing a sheet on which an image is printed by the image forming apparatus, such as in a multifunction peripheral.

The housing 10 is a rectangular parallelepiped casing made of resin. In the housing 10, a sheet discharge section is formed on an upper surface thereof.

The sheet feed cassette 11 is provided detachably with respect to the housing 10. The sheet feed cassette 11 accommodates the sheet, which is an image receiving medium on which the image is formed.

The conveyance system 12 conveys a sheet supplied from the sheet feed cassette 11. The conveyance system 12 has a pickup roller 21, a conveyance roller 22, a registration roller 23 and a sheet discharge roller 24. The pickup roller 21, the conveyance roller 22, the registration roller 23, and the sheet discharge roller 24 are each driven by a motor or the like under the control of the controller 15.

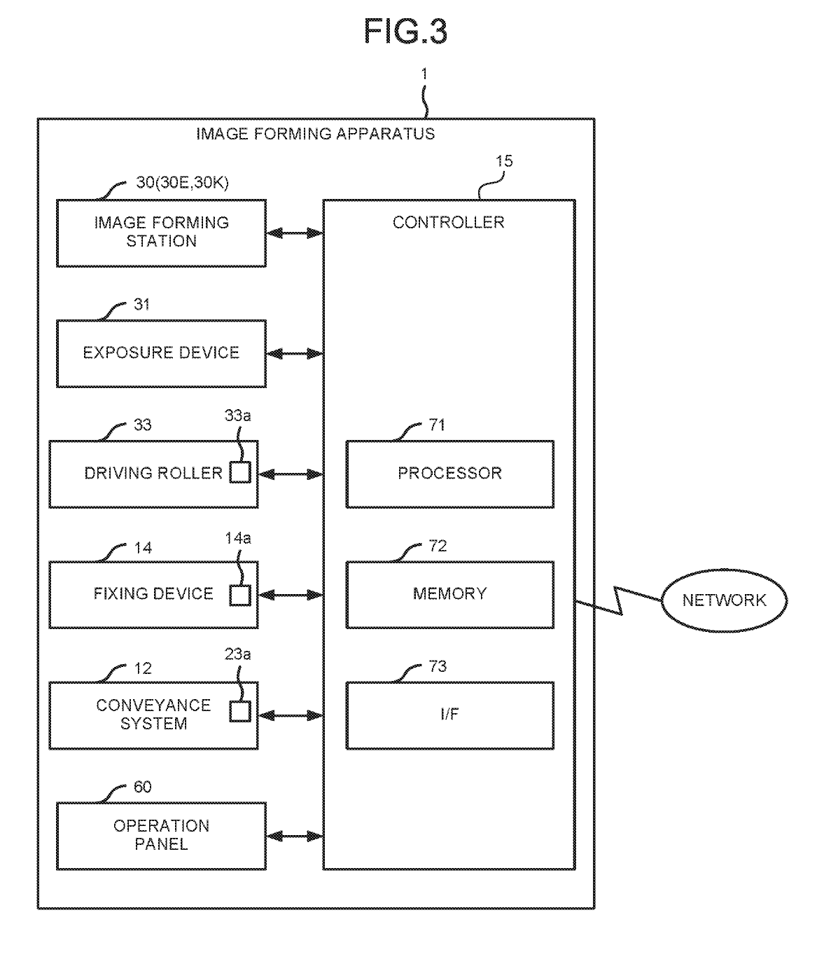

The pickup roller 21 picks up the sheets one by one from the sheet feed cassette 11. The conveyance roller 22 conveys the sheet taken out by the pickup roller 21 towards the registration roller 23 side. The registration roller 23 conveys the sheet to a secondary transfer position between a transfer belt 32 and a secondary transfer roller 35. For example, the sheet is temporarily stopped in the front of the registration roller 23 and then sent to the secondary transfer position in accordance with a timing at which the toner image on the transfer belt 32 moves. The registration roller 23 is rotated by a registration motor 23a (refer to FIG. 3) described later to convey the sheet. The sheet that passed through the secondary transfer position is supplied to the fixing device 14.

The fixing device 14 performs the fixing process to fix the toner image formed on the sheet to the sheet. The fixing device 14 has a pressure roller 51 and a fixing belt 52 described later. The fixing device 14 applies heat and pressure to a toner image on the sheet passing through a nip part between the fixing belt 52 and the pressure belt 51 to fix the toner image on the sheet. The fixing belt 52 and the pressure roller 51 convey the sheet in a heated and pressurized state by being rotated by a fixing motor 14a (refer to FIG. 3) described later. The sheet to which the fixing process is performed by the fixing device 14 is discharged to the sheet discharge section by the sheet discharge roller 24.

The image forming unit 13 includes an image forming station 30E, an image forming station 30K, an exposure device 31, a transfer belt 32, a driving roller 33, a driven roller 34, a secondary transfer roller 35, tension rollers 36 and 37, and the like.

The image forming station 30E forms a toner image with the decolorable toner. The image forming station 30E transfers the toner image formed with the decolorable toner onto the outer circumferential surface of the transfer belt 32. The image forming station 30K forms a toner image with the non-decolorable toner. In the present embodiment, it is assumed that the image forming station 30K forms an image with black toner as the non-decolorable toner. The image forming station 30K transfers the toner image formed with the non-decolorable toner onto an outer circumferential surface of the transfer belt 32. The transfer belt 32 is a transfer body on which an image is formed by each of the image forming stations 30E and 30K. In the case of forming a color image with the non-decolorable toner, it is possible to provide a plurality of the image forming stations for forming images with non-decolorable toners of respective colors as color images.

The exposure device 31 irradiates an outer circumferential surface of a photoconductive drum 41 as an image carrier in each of the image forming stations 30E and 30K with a laser beam. The exposure device 31 includes a light emitting section for emitting laser beam and an optical system such as a polygon mirror for guiding the laser beam toward the surface of the photoconductive drum 41. The exposure device 31 scans the surface of the photoconductive drum 41 with laser beam emitted by the light emitting section in response to a control signal corresponding to image data given from the controller 15.

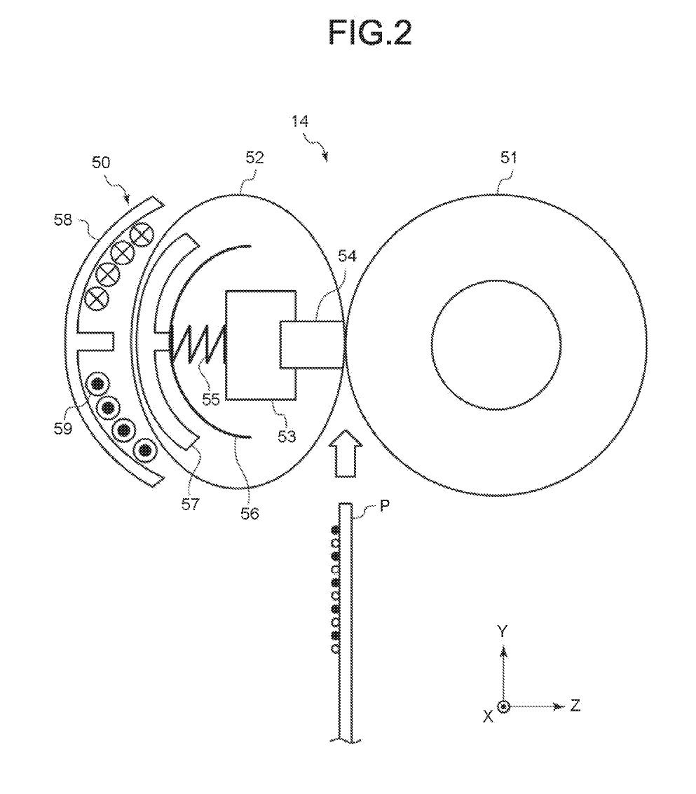

The transfer belt 32 is wound around the driving roller 33, the driven roller 34, and the tension rollers 36 and 37. The transfer belt 32 rotates in a direction of an arrow shown in FIG. 2 by rotation of the driving roller 33. The driving roller 33 is rotated by a driving motor 33a (refer to FIG. 3) described later to drive the transfer belt 32. The toner image formed by each of the image forming stations 30E and 30K is transferred onto the outer circumferential surface of the transfer belt 32 at a transfer position (referred to herein as a primary transfer position) for each of the image forming stations 30E and 30K. The driving roller 33 and the secondary transfer roller 35 are provided facing each other to form a secondary transfer position.

The image forming station 30 (30E, 30K) includes a photoconductive drum 41 (41e, 41k), a charging device 42 (42e, 42k), a primary transfer roller 43 (43e, 43k), a developing device 44 (44e, 44k), and a cleaner 45 (45e, 45k). Along the outer circumferential surface of the photoconductive drum 41, the charging device 42, the developing device 44, and the cleaner 45 are arranged. The photoconductive drum 41 rotates according to the movement of the transfer belt 32, as indicated by an arrow in FIG. 1. The charging device 42 charges the outer circumferential surface of the photoconductive drum 41 to a predetermined potential. The outer circumferential surface of the photoconductive drum 41 charged to the predetermined potential is irradiated with the laser beam from the exposure device 31. As a result, an electrostatic latent image is formed on the outer circumferential surface of the photoconductive drum 41.

The developing device 44 supplies a developer composed of the toner and a carrier to the electrostatic latent image formed on the surface of the photoconductive drum 41. For example, the developing device 44e develops an electrostatic latent image on the photoconductive drum 41e with a developer composed of the decolorable toner and a carrier. The decolorable toner becomes transparent (i.e., decolored) when being heated to the decoloring temperature. The decolorable toner is, for example, a blue (E) toner mainly composed of a leuco dye. The decolorable toner is decolored at a higher temperature (i.e., decoloring temperature) than a first fixing temperature for fixing an image formed with the decolorable toner on the sheet.

The developing device 44k develops an electrostatic latent image on the photoconductive drum 41k with a developer composed of the non-decolorable toner and a carrier. The color tone of the non-decolorable toner hardly changes depending on the temperature. For example, the non-decolorable toner is a black (K) toner mainly containing pigment.

The primary transfer roller 43 is arranged to face the outer circumferential surface of the photoconductive drum 41 across the transfer belt 32 in each of the image forming stations 30E and 30K. A position at which the transfer belt 32 is sandwiched between the photoconductive drum 41 and the primary transfer roller 43 is the primary transfer position. At the primary transfer position, the toner image on the photoconductive drum 41 developed by the developing device 44 is transferred onto the outer circumferential surface of the transfer belt 32. The cleaner 45 cleans the toner left on the surface of the photoconductive drum 41 after transferring the toner image onto the transfer belt 32.

The toner image transferred onto the outer circumferential surface of the transfer belt 32 by the image forming station 30 is transferred onto the sheet at the secondary transfer position as the transfer belt 32 moves. The sheet onto which the toner image is transferred at the secondary transfer position where the driving roller 33 and the secondary transfer roller 35 face each other is further supplied to the fixing device 14. Here, it is assumed that there is a predetermined distance between the secondary transfer position and the fixing position in the fixing device 14.

Next, the configuration of the fixing device 14 is described.

FIG. 2 is a diagram illustrating an example of a configuration of the fixing device 14.

The fixing device 14 includes a heating unit (more generally referred to as a heater) 50, the pressure roller 51, the fixing belt 52, a holding member 53, a pressure pad 54, an elastic member 55, an aluminum member 56, and a magnetic shunt member 57.

The fixing belt 52 is a cylindrical member with a direction orthogonal to the sheet conveyance direction as a longitudinal direction thereof, and a length thereof is larger than a width (dimension in a Y axis direction) of the sheet. For example, the fixing belt 52 is made of a polyimide sleeve. A metal layer such as a Ni layer and a Cu layer is formed at the outer side of the fixing belt 52. The fixing belt 52 is rotatably supported around the holding member 53.

The heating unit 50 is a heater for heating the fixing belt 52. The heating unit 50 is arranged adjacent to the fixing belt 52. The heating unit 50 includes a core 58 made of ferrite and a coil 59. A high frequency current flows through the coil 59, thereby generating a magnetic flux. The magnetic flux interlinks with the Ni layer and the Cu layer of the fixing belt 52 to heat the fixing belt 52. In the heating unit 50, the core 58 functions as a shield.

The pressure roller 51 includes a core made of metal with the direction orthogonal to the sheet conveyance direction as a longitudinal direction thereof, and a rubber layer laminated on the outer peripheral surface of the core. The length of the pressure roller 51 is approximately equal to that of the fixing belt 52. The pressure roller 51 is energized by the elastic member in a direction towards the fixing belt 52. The pressure roller 51 is pressed against the pressure pad 54 across the fixing belt 52. With these configurations, the surface of the pressure roller 51 and the surface of the fixing belt 52 are in close contact with each other. A part where the surface of the pressure roller 51 and the surface of the fixing belt 52 are in close contact with each other becomes a nip part through which the sheet to be subjected to the fixing process passes.

The fixing belt 52 is heated by the heating unit 50 and rotates by the rotation of the pressure roller 51. If a high frequency current is supplied to the coil 59 and the pressure roller 51 rotates, the fixing belt 52 is heated while rotating. The controller 15 controls the heating unit 50 in such a manner that the temperature of the fixing belt 52 reaches a control target temperature. The control target temperature is appropriately set by the controller 15.

The holding member 53 is a member extending in an X axis direction as a longitudinal direction thereof. The holding member 53 is fixed at inner side of the fixing belt 52. The pressure pad 54 is fixed to the holding member 53 at the fixing belt 52 side thereof, and the elastic member 55 is fixed to the holding member 53 at an opposite side of the pressure pad 54.

The pressure pad 54 is a member extending in the X axis direction, which is orthogonal to the sheet conveyance direction, as the longitudinal direction. The pressure pad 54 is made of a heat resistant phenolic resin. The pressure pad 54 is held by the holding member 53 at the inner side of the fixing belt 52. The surface of the pressure pad 54 opposite to a side where the pressure pad 54 is held by the holding member 53 is formed into a curved shape along the inner surface of the fixing belt 52.

The elastic member 55 is, for example, a compression spring and is fixed to the holding member 53. The magnetic shunt member 57 is attached to the elastic member 55 via the aluminum member 56 that curves along the fixing belt 52.

The magnetic shunt member 57 has the same size as the coil 59. The magnetic shunt member 57 has a property that a magnetic permeability decreases when the temperature thereof exceeds the Curie temperature. Therefore, if the temperature of the fixing belt 52 rises to some extent, the magnetic flux interlinking with the fixing belt 52 decreases. As a result, an increase in the temperature of the fixing belt 52 is suppressed.

Here, the fixing process for the decolorable toner and the fixing process for the non-decolorable toner are schematically described.

In a normal printing mode, in a case of fixing an image formed with the decolorable toner on the sheet, the fixing belt 52 is heated to the control target temperature based on a fixing temperature of the decolorable toner (first fixing temperature). In a case of fixing an image formed with the non-decolorable toner on the sheet, the fixing belt 52 is heated to the control target temperature based on a fixing temperature of the non-decolorable toner (second fixing temperature).

The decolorable toner and the non-decolorable toner differ in the fixing temperature used for the fixing process for fixing the toner image on the sheet. The first fixing temperature is lower than the second fixing temperature. The first fixing temperature is set to a temperature sufficiently lower than a decoloring temperature so that the decolorable toner is not decolored. In other words, the first fixing temperature for performing the fixing process on the sheet onto which the image formed with the decolorable toner is transferred is a temperature at which the image formed with the decolorable toner is fixed on the sheet without decoloring the decolorable toner.

In the first and second embodiments, if the fixing process is performed at the second fixing temperature, there is a possibility of decoloring the decolorable toner on the sheet. Therefore, the sheet onto which images containing the image formed with the decolorable toner and the image formed with the non-decolorable toner are transferred is subjected to the fixing process at a temperature (e.g., the first fixing temperature) lower than the second fixing temperature.

Next, an example of a configuration of a control system in the image forming apparatus 1 is described.

FIG. 3 is a block diagram illustrating an example of a configuration of the control system in the image forming apparatus 1.

In the image forming apparatus 1, the controller 15 is connected to various sections such as the conveyance system 12, the image forming station 30 (30E, 30K), the exposure device 31, the fixing device 14, and the operation panel 60. The controller 15 collectively controls various sections such as the fixing device 14, the conveyance system 12, the image forming station 30, the exposure device 31, the driving roller 33 and the operation panel 60.

For example, the registration roller 23 in the conveyance system 12 is driven by the registration motor 23a under the control of the controller 15. The registration roller 23 is rotated by the registration motor 23a. The controller 15 controls the registration roller 23 to send the sheet that reached the registration roller 23 to the secondary transfer position by turning on the registration motor 23a. The controller 15 controls a rotation speed of the registration roller 23 (conveyance speed at which the sheet is fed to the secondary transfer position) with a clock pulse for operation to be applied to the registration motor 23a.

The driving roller 33 is driven by the driving motor 33a under the control of the controller 15. The transfer belt 32 is rotated by the driving motor 33a. The controller 15 controls a moving speed of the transfer belt 32 (conveyance speed of the sheet at the secondary transfer position) with a clock pulse for operation to be applied to the driving motor 33a.

In the fixing device 14, the fixing belt 52 operates by the fixing motor 14a under the control of the controller 15. In the fixing device 14, the fixing belt 52 is rotated by the fixing motor 14a. The controller 15 controls a moving speed of the fixing belt 52 (conveyance speed of the sheet at the fixing position) with a clock pulse for operation to be applied to the fixing motor 14a.

The driving of the registration motor 23a, the driving motor 33a and the fixing motor 14a can be controlled separately.

As shown in FIG. 3, the controller 15 includes a processor 71, a memory 72, an interface (I/F) 73, and the like.

The processor 71 is, for example, a CPU (Central Processing Unit). The processor 71 realizes various processes by executing a program stored in the memory 72. The processor 71 is connected to various sections such as the conveyance system 12, the image forming station 30, the exposure device 31 and the fixing device 14 via an internal interface. The processor 71 collectively controls each section by executing the program.

The memory 72 includes a program memory, a work memory, a data memory, and the like. The program memory stores the program to be executed by the processor 71. The program memory is a nonvolatile memory such as a ROM (Read Only Memory), a NVM (Non-Volatile Memory), a HDD (Hard Disk Drive), a SSD (Solid State Drive), etc. The work memory is used for storing work data and the like. The work memory is a rewritable memory such as the RAM, for example. The data memory holds various data. The data memory is a rewritable nonvolatile memory such as the HDD, the SSD, etc., for example.

The interface 73 includes the internal interface for connecting to various sections in the image forming apparatus 1 and an external interface for connecting to an external device in a communicable manner. For example, the external interface is a network interface such as a LAN interface. The controller 15 connects to a network via the network interface as the interface 73. The external interface may be used for wireless communication. The external interface may be a serial interface which serially connects to an external storage device. The controller 15 enables information communication with a terminal such as a personal computer connected to the network via the interface 73.

The operation panel 60 is a user interface. For example, the operation panel 60 includes operation buttons and a display attached with a touch panel. The operation panel 60 displays an operation guidance, a GUI (Graphical User Interface), and the like on the display under the control of the controller 15. The operation panel 60 supplies information input by the user via the GUI or the operation buttons to the controller 15.

Next, the operation of the image forming apparatus 1 configured as described above is schematically described.

The image forming apparatus 1 operates by the controller 15 executing the program preinstalled while referring to various parameters. The image forming apparatus 1 has the normal printing mode in which the input image is printed on the sheet using the non-decolorable toner or the decolorable toner. The image forming apparatus 1 has a test printing mode in which a test pattern for confirming a printing position is printed using the non-decolorable toner and the decolorable toner.

First, the operation of the image forming apparatus 1 when the image is printed by using the decolorable toner in the normal printing mode is described.

The controller 15 controls the pickup roller 21 to take out a sheet from the sheet feed cassette 11, and controls the conveyance roller 22 to convey the sheet to the registration roller 23. The controller 15 controls the exposure device 31 and the image forming station 30E to form the toner image with the decolorable toner on the outer circumferential surface of the photoconductive drum 41e according to a printed image. The toner image formed with the decolorable toner formed on the photoconductive drum 41e is transferred (primarily transferred) onto the transfer belt 32. The controller 15 controls the registration roller 23 to convey the sheet towards a secondary transfer position between the transfer belt 32 and the secondary transfer roller 35 in accordance with a timing at which the toner image on the transfer belt 32 moves. As a result, the toner image formed with the decolorable toner is transferred from the transfer belt 32 onto the sheet.

The sheet onto which the toner image formed with the decolorable toner is transferred at the secondary transfer position is subjected to the fixing process at the fixing device 14. In a case of fixing the image formed with the decolorable toner on the sheet, the controller 15 uses the heating unit 50 to heat the fixing belt 52 to the control target temperature based on the fixing temperature of the decolorable toner. The fixing temperature of the decolorable toner is lower than the decoloring temperature at which the decolorable toner is decolored and is lower than the fixing temperature of the non-decolorable toner.

The controller 15 controls the conveyance system. 12 to send the sheet onto which the toner image formed with the decolorable toner is transferred to a nip part between the pressure roller 51 and the fixing belt 52 heated to the control target temperature based on the first fixing temperature. The sheet onto which the toner image formed with the decolorable toner is transferred is heated and pressurized when it passes through the nip part as the fixing position. As a result, the toner image formed with the decolorable toner is fixed on the sheet when the sheet passes through the nip part of the fixing device 14. The sheet that passed through the fixing device 14 is discharged to the sheet discharge section by the sheet discharge roller 24.

The operation of the image forming apparatus 1 when an image is printed using the non-decolorable toner in the normal printing mode is described.

The controller 15 controls the pickup roller 21 to take out a sheet from the sheet feed cassette 11, and controls the conveyance roller 22 to convey the sheet to the registration roller 23. The controller 15 controls the exposure device 31 and the image forming station 30K to form the toner image with the non-decolorable toner on the photoconductive drum 41k according to a printed image. The toner image formed on the photoconductive drum 41k is transferred (primarily transferred) onto the transfer belt 32. The controller 15 controls the registration roller 23 to convey the sheet to the secondary transfer position in accordance with a timing at which the toner image on the transfer belt 32 moves. As a result, the toner image formed with the non-decolorable toner is transferred onto the sheet.

The sheet onto which the toner image formed with the non-decolorable toner is transferred at the secondary transfer position is subjected to the fixing process in the fixing device 14. In a case of fixing the toner image formed with the non-decolorable toner on the sheet, the controller 15 controls the fixing device 14 to heat the fixing belt 52 such that the temperature of the fixing belt 52 reaches the control target temperature based on the fixing temperature of the non-decolorable toner.

The controller 15 controls the conveyance system. 12 to send the sheet onto which the toner image formed with the non-decolorable toner is transferred to the nip part between the pressure roller 51 and the fixing belt 52 heated to the control target temperature based on the second fixing temperature. The sheet onto which the toner image formed with the non-decolorable toner is transferred is heated and pressurized when it passes through the nip part as the fixing position. As a result, the toner image formed with the non-decolorable toner is fixed on the sheet when the sheet passes through the fixing device 14. The sheet that passed through the fixing device 14 is discharged to the sheet discharge section by the sheet discharge roller 24.

Next, an operation of confirming the position where the image forming apparatus 1 prints an image is described.

An operation of confirming a printing position of the toner image formed by the image forming station 30E (referred to herein as a first toner image) and the printing position of the toner image formed by the image forming station 30K (referred to herein as a second toner image) is described.

The image forming apparatus 1 forms the first toner image using the decolorable toner with the image forming station 30E. The image forming apparatus 1 forms the second toner image using the non-decolorable toner with the image forming station 30K. The image forming apparatus 1 prints a test pattern for confirming the printing position of the first toner image formed with the decolorable toner by the image forming station 30E and the printing position of the second toner image formed with the non-decolorable toner by the image forming station 30K on the sheet.

The test pattern is constituted by the toner image formed by the decolorable toner and the toner image formed by the non-decolorable toner. In the test printing mode, the image forming apparatus 1 prints the test pattern with the image forming station 30E and the image forming station 30K. Based on the printing result of the test pattern, an operator determines whether or not the printing position of the image formed with the decolorable toner and the printing position of the image formed with the non-decolorable toner are normal.

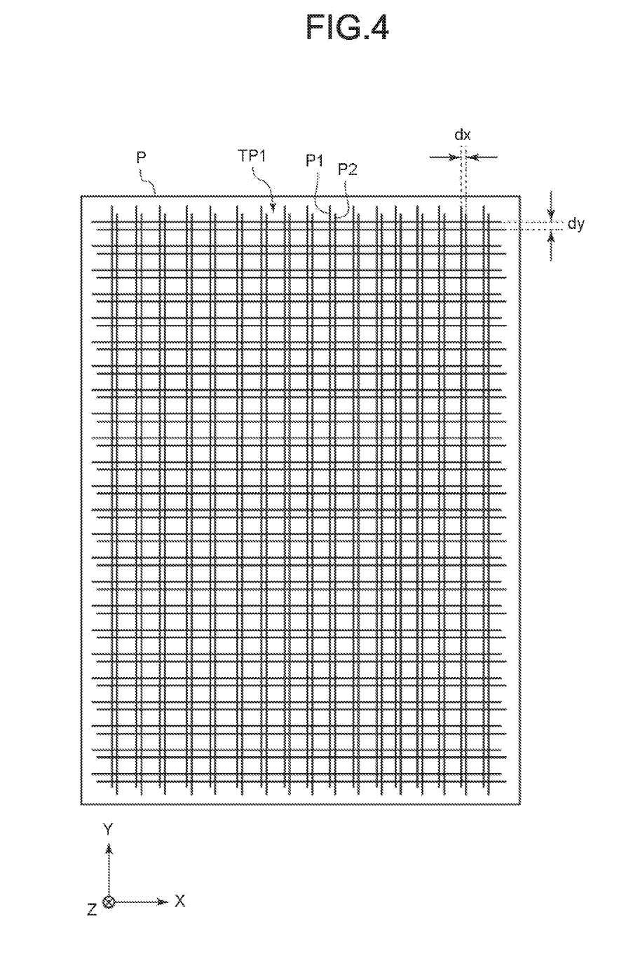

FIG. 4 is a diagram illustrating an example of a test pattern TP1 printed by the image forming apparatus 1 in the test printing mode according to the first embodiment.

The test pattern TP1 shown in FIG. 4 includes a first pattern P1 formed with the decolorable toner and a second pattern P2 formed with the non-decolorable toner. It is assumed that the first pattern P1 and the second pattern P2 are the same pattern. In the example shown in FIG. 4, the first pattern P1 and the second pattern P2 each are lattice-shaped patterns formed by a plurality of line patterns parallel to the X axis and a plurality of line patterns parallel to the Y axis. In the first pattern P1 and the second pattern P2, a plurality of line patterns parallel to the X axis and a plurality of line patterns parallel to the Y axis are arranged at a fixed array interval (for example, about 10 mm).

The first pattern P1 and the second pattern P2 that form the test pattern TP1 are printed on one sheet such that the patterns are shifted from each other by a predetermined shift amount D (dx, dy). The shift amount D is set in such a manner that lines arranged in the same direction of the first pattern P1 and the second pattern P2 do not overlap with each other. Specifically, the shift amount dy in the Y axis direction is set in such a manner that the lines parallel to the X axis of the first pattern P1 do not overlap with the lines parallel to the X axis of the second pattern P2. The shift amount dx in the X axis direction is set in such a manner that the lines parallel to the Y axis of the first pattern P1 do not overlap with the lines parallel to the Y axis of the second pattern P2.

By printing the first pattern P1 formed with the decolorable toner and the second pattern P2 formed with the non-decolorable toner in a shifted manner, it is possible to reduce the part where the toner image formed with the decolorable toner overlaps with the toner image formed with the non-decolorable toner. By printing the first pattern P1 and the second pattern P2 at a predetermined shift amount, it is possible to confirm from the printing result whether the printing position of the toner image formed with the decolorable toner and the printing position of the toner image formed with the non-decolorable toner are in a correct positional relationship.

In other words, the operator can confirm whether or not the shift between the first pattern P1 and the second pattern P2 in the printing result of the test pattern TP1 is the set shift amount D. If the shift between the first pattern P1 and the second pattern P2 is the shift amount D, the operator can confirm that the printing position of the toner image formed with the decolorable toner and the printing position of the toner image formed with the non-decolorable toner are correct. If the shift between the first pattern P1 and the second pattern P2 is not the shift amount D, the printing position of the toner image formed with the decolorable toner and the printing position of the toner image formed with the non-decolorable toner are incorrect, and therefore the operator adjusts the printing positions.

The shift amount between the first pattern P1 and the second pattern P2 is set according to the array interval of the line patterns arranged along the X axis and the Y axis. For example, when a plurality of line patterns parallel to the X axis and the Y axis is arranged at an array interval of 10 mm, the shift amount dx and dy is less than 10 mm (for example, about several mm). The shift amount D between the first pattern P1 and the second pattern P2 may be a shift amount that the operator can easily confirm from the printing result of the test pattern TP1.

For example, the shift amount dy between the first pattern P1 and the second pattern P2 may be half of the array interval of the line patterns arranged in parallel with the X axis. The shift amount dx between the first pattern P1 and the second pattern P2 may be half of the array interval of the line patterns arranged in parallel with the Y axis. If a set value of the shift amount D (dx, dy) is half of the array interval, the operator can easily determine whether the shift between the first pattern P1 and the second pattern P2 in the printing result of the test pattern TP1 matches the set value.

Based on the printing result of the test pattern TP1, the operator performs an alignment adjustment process on the toner images formed by the image forming stations 30E and 30K. The alignment adjustment process includes a process of adjusting various parameters to be referred to by the controller 15. The operator performs alignment adjustment process such that the shift between the first pattern P1 and the second pattern P2 in the printing result of the test pattern TP1 becomes the set shift amount.

Generally, if the first toner image formed with the first toner and the second toner image formed with the second toner are superimposed and printed on the sheet, there is a high possibility that fixing failure of the toner occurs. In the test pattern TP1 described above, since the first toner image and the second toner image are printed on the sheet by being shifted from each other, the overlapping part between the first toner and the second toner is reduced. Therefore, in the test pattern TP1 according to the first embodiment, the operator can recognize a case where the printing positions need to be adjusted.

As a result, it is possible to reduce the possibility of pollution of the fixing belt 52 by the toner which is not well fixed on the sheet due to the fixing failure.

The fixing temperature of the decolorable toner and the fixing temperature of the non-decolorable toner are different, and the decolorable toner is decolored when heated at a temperature equal to or higher than the decoloring temperature. For this reason, the image forming apparatus 1 performs the fixing process on the sheet onto which the test pattern TP1 is transferred at a temperature lower than the second fixing temperature (the fixing temperature of the non-decolorable toner). If the fixing process is carried out at the temperature lower than the second fixing temperature on the sheet onto which the toner image formed with the decolorable toner and the toner image formed with the non-decolorable toner are transferred in a completely overlapped manner, a large amount of toners cannot be well fixed.

The image forming apparatus 1 according to the first embodiment prints, on the sheet, the test pattern TP1 in which the first pattern P1 formed with the decolorable toner and the second pattern P2 formed with the non-decolorable toner are shifted from each other. In such a test pattern TP1, a part where the toner image formed with the decolorable toner and the toner image formed with the non-decolorable toner overlap is reduced. Therefore, according to the first embodiment, even if the fixing process is performed on the sheet onto which the test pattern TP1 is transferred at the temperature lower than the fixing temperature of the non-decolorable toner, the fixing failure of the toner can be reduced.

### Second Embodiment

The second embodiment is applicable to the image forming apparatus 1 having the configuration shown in FIG. 1, FIG. 2 and FIG. 3 described in the first embodiment. Therefore, a detailed description of the configuration of the image forming apparatus 1 according to the second embodiment is omitted. However, the image forming apparatus 1 according to the second embodiment has a function of controlling the conveyance speed for one sheet P by separately controlling respective motors by the controller 15.

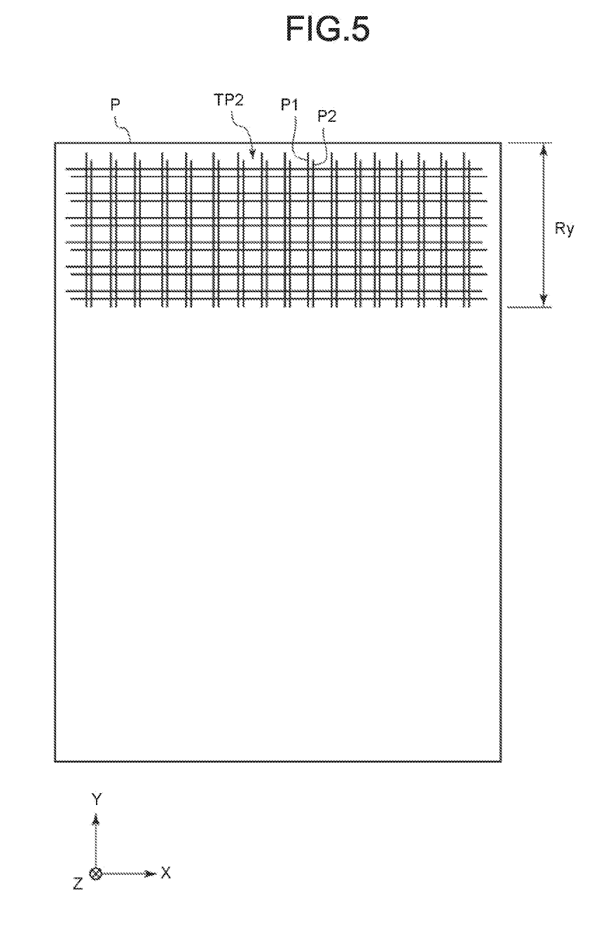

FIG. 5 is a diagram illustrating an example of a test pattern TP2 printed by the image forming apparatus 1 in the test printing mode according to the second embodiment.

The test pattern TP2 includes the first pattern P1 formed with the decolorable toner and the second pattern P2 formed with the non-decolorable toner. Like the test pattern TP1 shown in FIG. 4 described in the first embodiment, the test pattern TP2 is obtained by shifting the first pattern P1 and the second pattern P2 by a predetermined shift amount. However, the second embodiment may be applied to the image forming apparatus 1 which prints a test pattern in which the toner image formed with the decolorable toner completely overlaps with the toner image formed with the non-decolorable toner.

The test pattern TP2 shown in FIG. 5 is printed in a printing area having a predetermined length Ry in the sheet conveyance direction (Y axis direction). The length Ry of the printing area of the test pattern TP2 in the sheet conveyance direction is set to be shorter than a conveyance distance from the secondary transfer position to the fixing position in the image forming apparatus 1. For example, if the conveyance distance from the secondary transfer position to the fixing position is 104 mm, the length Ry of the printing area of the test pattern TP2 is set to be smaller than 104 mm (e.g., 100 mm with about 4 mm as a margin). Here, the secondary transfer position is a position where the transfer belt 32 and the secondary transfer roller 35 contact with each other, and is a position where the image is transferred from the transfer belt 32 onto the sheet. The fixing position is the nip part between the fixing belt 52 and the pressure roller 51 in the fixing device 14, and is a position where the sheet is actually heated and subjected to the fixing process.

The image forming apparatus 1 according to the second embodiment controls the conveyance speed of one sheet P by separately controlling the registration motor 23a, the driving motor 33a, and the fixing motor 14a. Specifically, in the second embodiment, the controller 15 separately controls a conveyance speed (e.g., to a first conveyance speed) when the test pattern TP2 is transferred onto the sheet and a conveyance speed (e.g., to a second conveyance speed) when the toner image of the test pattern TP2 is fixed on the sheet.

By setting the length Ry of the printing area of the test pattern TP2 to be shorter than the conveyance distance from the secondary transfer position to the fixing position, the conveyance speed of the sheet can be changed after the transfer of the test pattern TP2. Specifically, even if the conveyance speed of the sheet is changed (e.g., reduced) after the printing area passes through the secondary transfer position, the image of the test pattern TP2 on the sheet is not affected. If the printing area of the test pattern TP2 passes through the secondary transfer position, the image forming apparatus 1 according to the second embodiment reduces the conveyance speed of the sheet to the second conveyance speed slower than the first conveyance speed. For example, the second conveyance speed may be about ½ to ⅓ of the first conveyance speed.

There is a possibility that the decolorable toner may be decolored when heated at the fixing temperature of the non-decolorable toner in the normal printing mode. Therefore, the sheet onto which the test pattern TP2 including the toner image formed with the decolorable toner and the toner image formed with the non-decolorable toner is transferred is subjected to the fixing process at a temperature lower than the second fixing temperature of the non-decolorable toner.

On the other hand, if the sheet onto which the test pattern TP2 is transferred is subjected to the fixing process at the first fixing temperature, there is a possibility that the fixing failure of the non-decolorable toner may occur. For this reason, the image forming apparatus 1 according to the second embodiment heats the fixing belt 52 at a temperature lower than the second fixing temperature while performing control to lengthen the time for applying the heat to the sheet.

If the conveyance speed of the sheet is reduced after the transfer of the test pattern TP2, the conveyance speed of the sheet passing through the fixing position (nip part) of the fixing device 14 is slowed down. If the conveyance speed of the sheet passing through the fixing position of the fixing device 14 is slowed down, the time for applying the heat to the sheet is lengthened. As a result, the image forming apparatus 1 can take a long time to apply the heat to the sheet, and even when the fixing belt is at a low temperature, the fixing failure of the toner can be suppressed.

Next, the sheet conveyance control in a case (test printing mode) in which the image forming apparatus 1 according to the second embodiment prints the test pattern TP2 on the sheet is described.

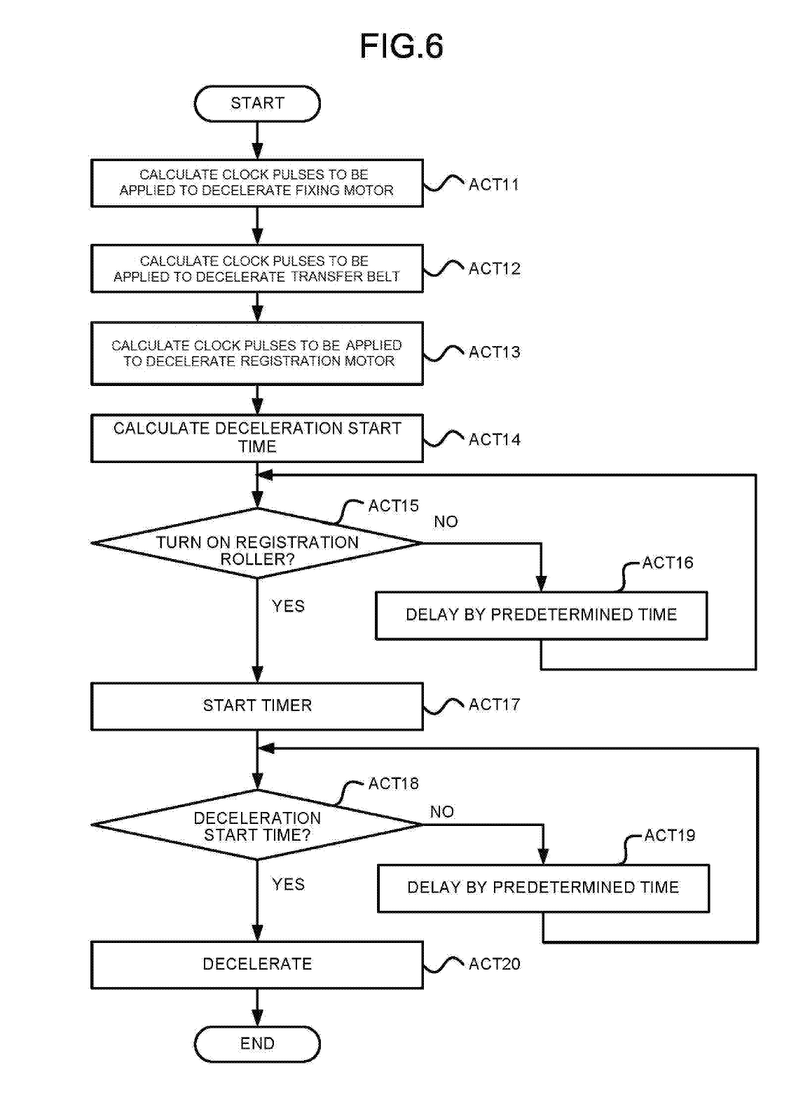

FIG. 6 is a flowchart for depicting an example of the sheet conveyance control operation in the test printing mode by the image forming apparatus 1 according to the second embodiment.

The processor 71 of the controller 15 starts the test printing mode in which the test pattern TP2 is printed on the sheet in response to an instruction by the operator in the operation panel 60. The processor 71 may start the test printing mode in which the test pattern TP2 is printed on the sheet in response to a request from the external device. When the test printing mode is started, the processor 71 performs control to form the toner image of the test pattern TP2 on the transfer belt 32 using the image forming stations 30E and 30K, while starting the conveyance control on one sheet P on which the test pattern TP2 is printed.

In the conveyance control of the sheet P, the processor 71 calculates various types of control data for conveying the sheet P. In the test printing mode, after transferring the test pattern TP2 onto the sheet, the conveyance speed of the sheet is reduced, and long time is taken to perform the fixing process on the sheet. Specifically, the processor 71 conveys the sheet at the first conveyance speed and transfers the test pattern TP2 onto the printing area of the sheet. After transferring the test pattern TP2 onto the sheet, the processor 71 reduces the conveyance speed of the sheet to the second conveyance speed slower than the first conveyance speed. In order to perform such conveyance control, the processor 71 calculates the control data for each motor for reducing the conveyance speed of the sheet.

First, the processor 71 calculates a clock pulse for operation to be applied to the fixing motor 14a in a case of reducing the conveyance speed of the sheet (ACT 11). The processor 71 calculates a clock pulse for operation to be applied to the driving motor 33a for rotating the driving roller 33 which moves the transfer belt 32 in a case of reducing the conveyance speed of the sheet (ACT 12). Furthermore, the processor 71 calculates a clock pulse for operation to be applied to the driving motor 23a for rotating the registration roller 23 in a case of reducing the conveyance speed of the sheet (ACT 13). The processor 71 stores the calculated clock pulses for operation in the memory 72.

The sheet sent out from the registration roller 23 is conveyed at the first conveyance speed, and the test pattern TP2 is transferred onto the printing area. After the transfer of the test pattern TP2 is completed, the conveyance speed of the sheet is reduced, and the sheet is conveyed at the second conveyance speed used for the fixing process. In other words, the processor 71 performs control to reduce the conveyance speed of the sheet after the printing area of the test pattern TP2 on the sheet passes through the secondary transfer position. Therefore, the processor 71 is necessary to set a timing at which the reduction of the conveyance speed of the sheet is started.

The processor 71 calculates the time (i.e., deceleration start time) for starting the reduction of the conveyance speed of the sheet based on the position of the sheet P and the conveyance speed when the test pattern TP2 is transferred onto the sheet P (ACT 14). For example, the processor 71 calculates the deceleration start time starting from a timing at which the registration roller 23 is turned on, which is a timing for starting the process of transferring the toner image onto the sheet. In this case, the processor 71 calculates, as the deceleration start time, the time until the printing area (i.e., area where the test pattern TP2 is transferred) of the sheet P passes through the secondary transfer position since the registration roller 23 is turned on. The processor 71 calculates the deceleration start time according to the conveyance speed (i.e., first conveyance speed) of the sheet when the toner image of the test pattern TP2 is transferred from the transfer belt onto the sheet P, the conveyance distance from the registration roller 23 to the secondary transfer position, and the length Ry of the printing area in the sheet conveyance direction.

After calculating the deceleration start time, the processor 71 determines the timing at which the registration roller 23 is turned on as the start of the deceleration start time (ACT 15). If the registration roller 23 is not turned on (No in ACT 15), the processor 71 determines whether the registration roller 23 is turned on at every predetermined delay time (ACT 16).

If it is determined that the register roller 23 is turned on (Yes in ACT 15), the processor 71 starts a timer for measuring the elapsed time (ACT 17). If the registration roller 23 is turned on, the sheet P is conveyed to the secondary transfer position. At the secondary transfer position, the toner image of the test pattern TP2 is transferred from the transfer belt 32 onto the sheet P. On the other hand, the timer started at the timing at which the registration roller 23 is turned on measures the elapsed time until the deceleration start time.

After starting the timer, the processor 71 determines whether the time measured by the timer reaches the deceleration start time (ACT 18). If the time measured by the timer does not reach the deceleration start time (No in ACT 18), the processor 71 determines whether the time measured by the timer reaches the deceleration start time at every predetermined delay time (ACT 19).

If the time measured by the timer reaches the deceleration start time (Yes in ACT 18), the processor 71 starts reducing the conveyance speed of the sheet (ACT 20). For example, the processor 71 reduces the conveyance speed of the sheet by using clock pulses calculated by the processes in ACT 11 to ACT 13 as the clock pulses for operation to be applied to respective motors. Here, the deceleration start time is calculated based on the time at which the printing area of the test pattern TP2 on the sheet passes through the secondary transfer position. Therefore, when the time measured by the timer reaches the deceleration start time, since the transfer of the test pattern TP2 onto the sheet is completed, the test pattern TP2 is not affected by the reduction of the conveyance speed.

If the deceleration start time is reached and the conveyance speed of the sheet is reduced, the conveyance speed of the sheet onto which the test pattern TP2 is transferred is changed to the second conveyance speed slower than the first conveyance speed. As a result, the sheet onto which the test pattern TP2 is transferred is conveyed to the fixing device 14 at the second conveyance speed. The fixing device 14 applies the heat to the sheet P conveyed at the second conveyance speed at the nip part to perform the fixing process. As a result, the fixing device 14 takes a long time to perform the fixing process on the sheet onto which the test pattern TP2 is transferred.

As described above, the image forming apparatus 1 according to the second embodiment reduces the conveyance speed of the sheet after transferring the test pattern onto the sheet in the test printing mode. As a result, the image forming apparatus 1 can lengthen the time required by the fixing process for fixing the toner image of the test pattern TP2 on the sheet. As a result, the image forming apparatus 1 can take a long time to apply the heat from the fixing belt to the sheet and can suppress the fixing failure of the toner even if the temperature of the fixing belt is low.

The image forming apparatus 1 according to the second embodiment sets the printing area of the test pattern such that the sheet is supplied to the fixing position after the transfer of the test pattern onto the sheet is completed. In other words, the image forming apparatus according to the second embodiment sets the length Ry of the printing area where the test pattern is printed in the sheet conveyance direction to be shorter than the conveyance distance between the secondary transfer position and the fixing position. Furthermore, the image forming apparatus transfers the test pattern onto the sheet at the first conveyance speed, and performs the fixing process on the sheet at the second conveyance speed slower than the first conveyance speed.

According to the second embodiment, the image forming apparatus can take a long time to execute the fixing process on the sheet without affecting the image of the test pattern transferred onto the sheet. As a result, it is possible to transfer the toner image of the test pattern including the toner images formed with the decolorable toner and the non-decolorable toner onto the sheet with high quality, and it is possible to reduce the fixing failure of the toner.

The test pattern TP2 described in the second embodiment may be printed on the sheet by setting the printing area as described above at a tip portion in the sheet conveyance direction. In this case, as the sheet becomes long in the conveyance direction, the margin area next to the printing area of the test pattern TP2 becomes larger. The margin area next to the printing area of the test pattern TP2 has an effect of adsorbing the toner adhering to the surface of the fixing belt 52 due to the fixing failure. In other words, in the margin area next to the printing area of the test pattern TP2, an effect of cleaning the surface of the fixing belt 52 is obtained in some cases. Therefore, if the margin area next to the printing area of the test pattern TP2 is equal to or larger than a length of the outer circumference of the fixing belt 52, pollution caused by the toner attached to the fixing belt 52 can be reduced.

As described above, the first and the second embodiments are described, but the embodiments are not limited to being applied to the image forming apparatus described above. For example, in each of the above embodiments, the image forming apparatus comprising the image forming station 30K for forming the toner image using black non-decolorable toner and the image forming station 30E for forming the toner image using the decolorable toner is described. The present invention is not limited thereto, and each embodiment may be applied to an image forming apparatus having a plurality of the image forming stations for forming the toner image using plural types of the non-decolorable toners. For example, the image forming apparatus 1 may include five image forming stations, one of which uses the decolorable toner. In this case, the image forming apparatus may be a color laser printer capable of performing color printing by the non-decolorable toners of four colors and monochrome printing by the decolorable toner.

In each of the embodiments described above, the image forming apparatus 1 having the transfer belt 32 as the intermediate transfer member is described. The present invention is not limited thereto. The image forming apparatus according to each embodiment may include a transfer drum or the like as a transfer body instead of the transfer belt 32.

Further, in each of the above-described embodiments, the fixing device 14 includes the pressure roller 51 and the fixing belt 52 as a fixing member. The present invention is not limited thereto. The fixing device used in the image forming apparatus according to each embodiment may include a fixing roller or the like instead of the fixing belt 52. In this case, by slowing down the conveyance speed of the sheet when it passes through the fixing device which is the fixing roller, it is possible to fix the test pattern satisfactorily without decoloring the decolorable toner as well.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a first image forming section configured to form an image using a first toner;
a second image forming section configured to form an image using a second toner;
a controller configured to transfer a first toner image formed with the first toner by the first image forming section and a second toner image formed with the second toner by the second image forming section onto a medium, wherein the first toner image and the second toner image have a same pattern and are transferred onto the medium so as to be shifted with respect to each other; and
a fixing device configured to perform a fixing process on the medium onto which the first toner image and the second toner image are transferred.

2. The image forming apparatus according to claim 1, wherein
the first toner is a decolorable toner, and
the second toner is a non-decolorable toner.

3. The image forming apparatus according to claim 1, wherein
the pattern is a lattice-shaped pattern.

4. The image forming apparatus according to claim 3, wherein a first pattern formed on the medium from the first toner image and a second pattern formed on the medium from the second toner image are shifted with respect to each other by a predetermined amount.

5. The image forming apparatus according to claim 4, wherein the predetermined shift amount is one half of an interval between parallel lines that form the lattice-shaped pattern.

6. The image forming apparatus according to claim 1, wherein a region of the medium to which the first toner image and the second toner image are transferred has a length that is less than one-half of a length of the medium.

7. The image forming apparatus according to claim 1, wherein a region of the medium to which the first toner image and the second toner image are transferred has a length that is less than a distance between a first location where the first toner image and the second toner image are transferred to the medium and a second location where the fixing device performs a fixing process on the medium.

8. An image forming apparatus, comprising:
a first image forming section configured to form an image using a first toner;
a second image forming section configured to form an image using a second toner;
a conveyance roller configured to convey a medium to a transfer location where a first toner image and a second toner image are transferred to the medium;
a fixing device configured to apply heat to the medium conveyed by the conveyance at a fixing location downstream of the transfer location in a sheet conveyance direction; and
a controller configured to reduce a conveyance speed of the medium after the sheet passes through the transfer location and reaches the fixing location.

9. The image forming apparatus according to claim 8, wherein
the controller transfers the first toner image and the second toner image onto a printing area on the medium, and
a length of the printing area in the sheet conveyance direction is less than a distance from the transfer location to the fixing location.

10. The image forming apparatus according to claim 8, wherein
the first toner is a decolorable toner, and
the second toner is a non-decolorable toner.

11. The image forming apparatus according to claim 8, wherein
the pattern is a lattice-shaped pattern.

12. The image forming apparatus according to claim 11, wherein a first pattern formed on the medium from the first toner image and a second pattern formed on the medium from the second toner image are shifted with respect to each other by a predetermined amount.

13. The image forming apparatus according to claim 12, wherein the predetermined shift amount is one half of an interval between parallel lines that form the lattice-shaped pattern.

14. An image forming method, comprising:
forming a first toner image using a first toner and a second toner image using a second toner;
transferring the first toner image and the second toner image onto a medium, wherein the first toner image and the second toner image have a same pattern and are transferred onto the medium so as to be shifted with respect to each other; and
performing a fixing process on the medium onto which the first toner image and the second toner image are transferred.

15. The image forming method according to claim 14, wherein
the first toner is a decolorable toner, and
the second toner is a non-decolorable toner.

16. The image forming method according to claim 14, wherein
the pattern is a lattice-shaped pattern.

17. The image forming method according to claim 16, wherein a first pattern formed on the medium from the first toner image and a second pattern formed on the medium from the second toner image are shifted with respect to each other by a predetermined amount.

18. The image forming method according to claim 17, wherein the predetermined shift amount is one half of an interval between parallel lines that form the lattice-shaped pattern.

19. The image forming method according to claim 14, wherein a region of the medium to which the first toner image and the second toner image are transferred has a length that is less than a distance between a first location where the first toner image and the second toner image are transferred to the medium and a second location where the fixing device performs a fixing process on the medium.

20. The image forming method according to claim 19, further comprising:
controlling a conveyance speed of the sheet passing through the first location to be a first conveyance speed and
controlling a conveyance speed of the sheet passing through the second location to be a second conveyance speed that is less than the first conveyance speed.
